(19) United States
(12) Patent Application Publication
(10) Pub. No.: US 2024/0036721 A1
(43) Pub. Date: Feb. 1, 2024

(54) PORTABLE DEVICE WITH ADJUSTABLE STOPWATCH FEATURE

(71) Applicant: Oliver H. Melgrove, Vancouver (CA)

(72) Inventor: Oliver H. Melgrove, Vancouver (CA)

(21) Appl. No.: 18/380,184

(22) Filed: Oct. 15, 2023

Related U.S. Application Data
(63) Continuation of application No. 15/640,508, filed on Jul. 1, 2017, now abandoned.

(51) Int. Cl. G06F 3/04847; G06F 3/0488; G04G 9/00; G04F 10/00

(52) U.S. Cl. CPC G06F 3/04847; G06F 3/0488; G04G 9/00; G04F 10/00; G06F 3/167

(57) ABSTRACT

A device and method of presenting a stopwatch-like display to a user where the displayed time is different than actual time. The display appears to a casual observer like a stopwatch application, but it is actually a gag that advances time slower, faster and/or in irregular jumps compared to real time. The device permits the user of the device to control the degree and manner in which the time is advanced or retarded using one of a number of different subtle mechanisms that is undetectable to the casual observer, such as through the use of sounds that are inaudible to the human ear. Such a device is useful for amusement, prank or novelty purposes to trick someone into thinking that an amount of time has passed that is different than the actual time that has passed.

### RELATED APPLICATION

This application is a continuation of U.S. patent application Ser. No. 15/640,508, filed on Jul. 1, 2017, incorporated herein by reference.

### FIELD OF THE INVENTION

This invention relates to the field of timing devices and applications for portable devices, and more specifically to the field of amusement, trickery, magic tricks, gag, novelty devices and prank methods and products.

### BACKGROUND

Stopwatch applications running on mobile devices are common and frequently included as default application on smartphones. Such applications typically have start, stop, reset and lap features to allow timing of events. Such applications are very useful and widely used. Novelty software applications are used for prank purposes, novelty and gag purposes and for general amusement. What is needed is a stopwatch-like novelty application for amusement.

### SUMMARY

A device and method of presenting a stopwatch-like display to a user where the displayed time is different than actual time. The display appears to a casual observer like a stopwatch application, but it is actually a gag that displays time different than actual time, for example advancing time display slower, faster and/or in irregular jumps compared to actual time. The device permits the user of the device to control the degree and manner in which the time is advanced or retarded using one of a number of different subtle mechanisms that is controllable by the user but not detectable to the casual observer. Such an application is useful for amusement, prank, trickery or novelty purposes or as a magic trick, to convince someone that an amount of time has passed that is different than the actual time that has passed.

### BRIEF DESCRIPTION OF THE DRAWINGS

FIG. 1 illustrates internal components of an embodiment of a portable device such as a smartphone incorporating the invention.

FIG. 2 illustrates the memory and processor of a portable device such as a smartphone in an embodiment of the invention.

FIG. 3 illustrates the display of a portable device such as a smartphone in an embodiment of the invention.

FIG. 4 illustrates a portable device such as a smartphone in an embodiment of the invention.

FIG. 5 illustrates a portable device such as a smartphone in an embodiment of the invention.

FIG. 6 illustrates a portable device such as a smartphone in an embodiment of the invention.

FIG. 7 illustrates a portable device such as a smartphone in an embodiment of the invention.

FIG. 8 is a graph illustrating the underlying mechanism in an embodiment of the invention.

FIG. 9 is a graph illustrating time display slowdown in an embodiment of the invention.

FIG. 10 is a graph illustrating time display speedup in an embodiment of the invention.

FIG. 11 is a graph illustrating time display speedup in an embodiment of the invention.

### DETAILED DESCRIPTION

As a mechanism for amusement, a stopwatch like application is described that keeps time different than actual time, and in a way that can be controlled by the user of the application without the knowledge of others. A wide variety of modes of operation can be used. In one embodiment the application is available under the name ShamTime™ and can be configured with options to change the look and presentation of the user interface. In some embodiments the application is designed to look indistinguishable from a built in stopwatch feature. In some embodiment the application is available for free in a mode in which the display is labeled as an amusement device, and for a fee the application can be configured without such labeling. In some embodiments customization of the user interface is available for a fee. In some embodiments an API is provided in which third party software can interface to the application to control the manner in which time adjustments are made. In some embodiments downloadable modifications are available from the original distributor and/or third party developers that change the look and feel and/or provide customization of the configuration.

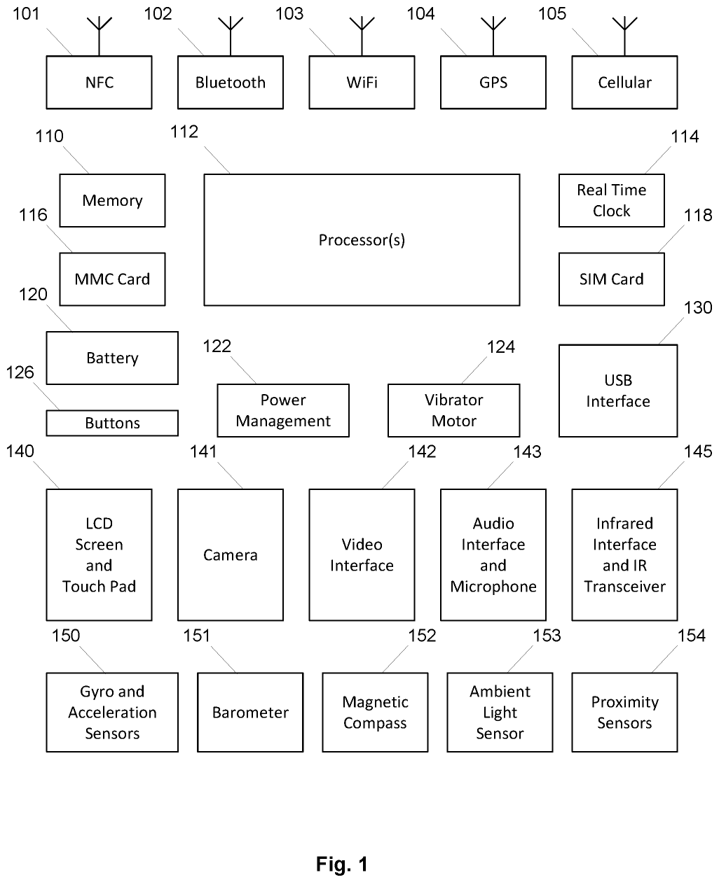

FIG. 1 illustrates components of a portable device such as a smartphone which may incorporate embodiments of the present invention. A portable device may incorporate one or more of the components illustrated in FIG. 1. Near field communication (NFC) module 101, Bluetooth module 102, Wi-Fi module 103, GPS module 104 and Cellular module 105 support wireless receipt and transmission of signals for a variety of different types of communications.

Processor(s) 112 represents the main processing unit of the portable device and may be comprised of one or more processors. Memory 110 stores instructions and data used by processor(s) 112. Other components on the portable device may include Multimedia Card (MMC) module 116, Real Time Clock module 114, SIM card module 118, Battery 120, Power management module 122 and Vibrator Motor 124. The portable device may include one or more of the interfaces shown in FIG. 1 such as USB interface 130, Infrared interface and Infrared Transceiver 145, Audio Interface and Microphone 143, Video Interface 142. The portable device may include physical Buttons 126, an LCD Screen and Touch Pad 140 and a Camera 141. The portable device may also include one or more of the sensors shown on FIG. 1 such as Gyro and Acceleration Sensors 150, Barometer 151, Magnetic Sensor 152, Ambient Light Sensor 153 and Proximity Sensors 154.

Other sensors not shown are possible, such as temperature measurement, humidity measurement and radiation detection. Proximity sensors can utilize a number of physical detection methods including capacitive coupling, inductive pickup, infrared, ambient light photo-detection, ultrasonic and Hall Effect.

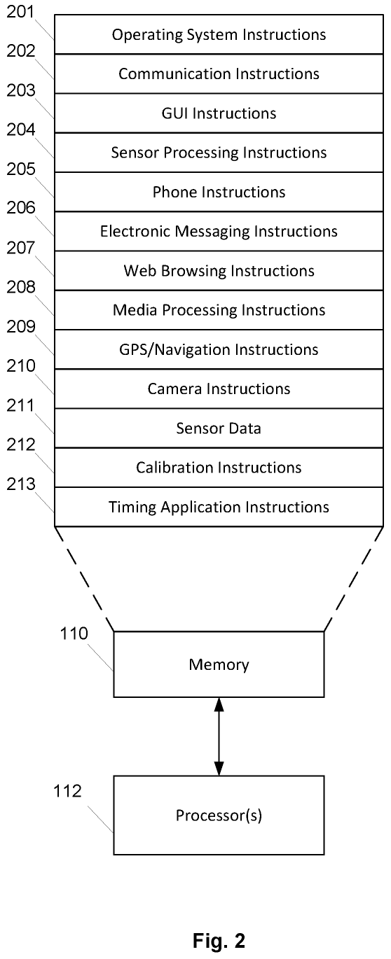

FIG. 2 illustrates more detail for Processor(s) 112 and Memory 110 in an embodiment of the portable device. Included in the Memory 110 are instructions and data for operating and managing the various components of the device. The Memory 110 includes processor instructions for the Operating System 201, and may include instructions for one or more of the illustrated components, including Communication 202, Graphical User Interface (GUI) 203, Sensor Processing 204, Phone 205, Electronic Messaging 206, Web Browsing 207, Media Processing 208, Global Positioning System (GPS)/Navigation 209, Camera 210, Sensor Data 211 and Calibration 212. Timing Application Instructions 213 are used in part to implement the features described below.

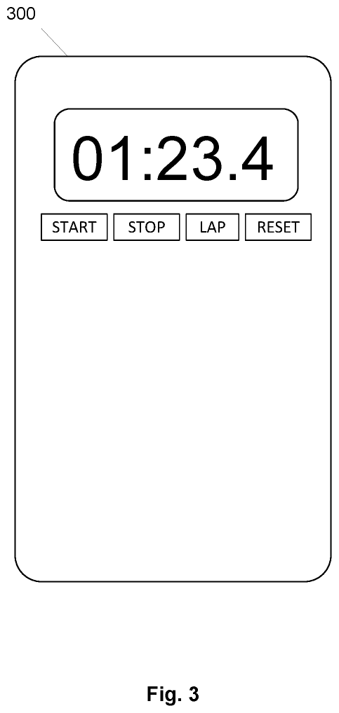

FIG. 3 illustrates the display 300 that is used on an embodiment of the present invention. The display is intended to look like a typical stopwatch, with buttons for the well-known functions of “START”, “STOP”, “LAP” and “RESET”. In some embodiments only certain buttons are displayed depending on the mode. For example, before timing has begun only the “START” button may be displayed, while running only the “STOP” and “LAP” buttons may be displayed, and while paused only the “START” and “RESET” buttons may be displayed. Other combinations of buttons and arrangements of buttons may be used.

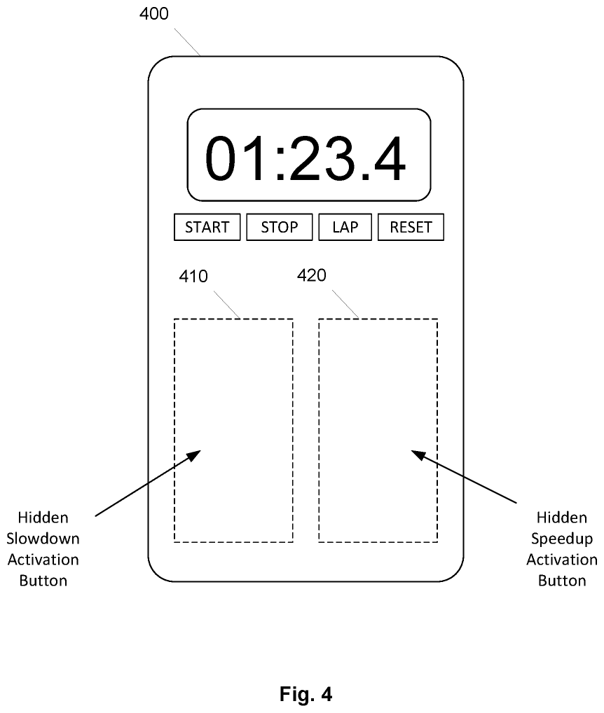

FIG. 4 illustrates a portable device 400 in an embodiment of the present invention. In this example a hidden area 410 of the touch screen is used to activate a slowdown mode for the timing device, and a second hidden area 420 of the touch screen is used to activate a speedup mode for the timing device. In some embodiments, touching the slowdown area will cause the stop watch to time at a slower rate and touching the speedup area will cause the stop watch to time at a faster rate. The size and location of the slowdown and speedup areas may be configurable by the user in certain embodiments. In some embodiment the length of time and/or the location and/or the movement of a touch influences whether the slowdown or speedup mode is activated and/or how much effect is generated. For example, a horizontal swipe might activate a slowdown mode and a vertical swipe might activate a speedup mode. Other combinations of touch based embodiments are possible in which the manner, duration and/or location of a touch are used to control the stopwatch mode. In addition to the use of the touch screen, physical buttons on the device can also be used. For example, the audio rocker buttons on a smartphone device can be used to activate a slowdown or speedup mode.

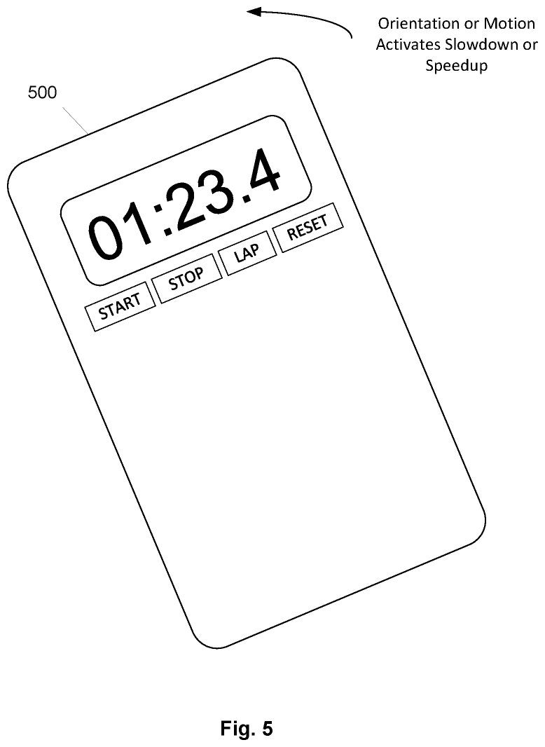

FIG. 5 illustrates a portable device 500 in an embodiment of the present invention. In this example physical movement and/or position of the device is used to activate a slowdown mode and/or a speedup mode for the timing device. In some embodiments a tilt of the device to the right will cause the speedup to be activated while a tilt to the left causes a speedup mode to be activated. The type of tilt may be configurable by the user in certain embodiments. In some embodiments the magnetic compass orientation of the portable device is used to control speedup and slowdown. For example orientation to North, South, East or West, or changes in such orientation can be used to activate a change in timing adjustment. In some embodiments the acceleration of the device is used, for example a sudden movement causes a mode to be activated. For example, a jerking motion to the left might activate a slowdown mode and a jerking motion might activate a speedup mode while a smooth movement might activate a slowdown mode. Other combinations of position/movement based embodiments are possible in which the physical orientation and/or movement of the device are used to control the stopwatch mode.

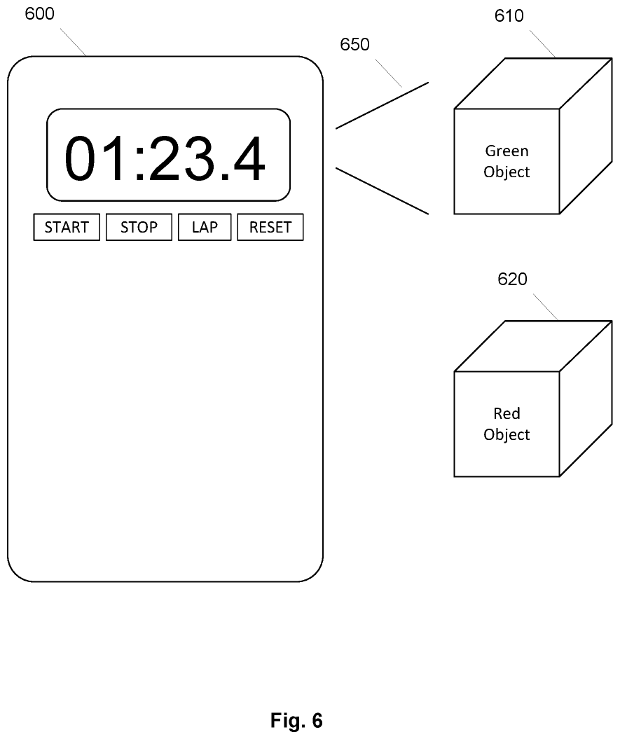

FIG. 6 illustrates a portable device 600 in an embodiment of the present invention. In this example the visual field 650 of the portable device are used to activate a slowdown mode and/or a speedup mode of the timing device. In some embodiments if a green object 610 is front of the camera the stop watch will time at a faster rate and if a red object 620 is in front of the camera the stop watch will time at a slower rate. The color and shape may be configurable by the user in certain embodiments. The ambient light sensor may also be used to control the slowdown and speedup functions. For example low light environments might activate a slowdown mode and higher light environment might activate a speedup mode. In some embodiments the color and/or pattern that activates the speedup and/or slowdown modes is configurable by the user. Specific colors, shapes and/or light levels could be configured to activate specific slowdown or speedup modes. For example, the user could train the device to recognize a certain specific shape as a trigger for a slowdown mode and a different specific shape as a trigger to activate a speedup mode. Other combinations of visual based embodiments are possible in which the color, pattern, shape, light and/or movement of the visual field are used to control the stopwatch mode. Additionally, the use of image processing capabilities such as face recognition can be utilized. For example, if the camera is pointed at certain face a speedup mode can be activated and when pointed at a different face a slowdown mode can be activated. Such faces can be generic and categorized or pre-configured for specific faces.

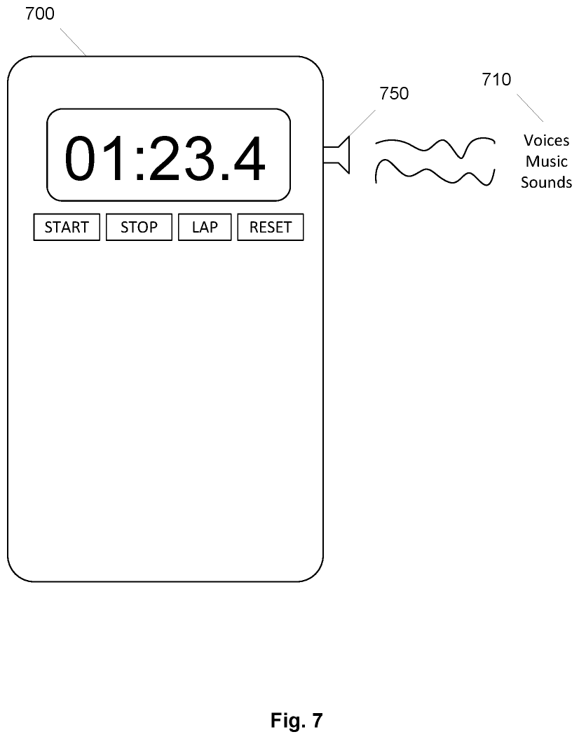

FIG. 7 illustrates portable device 700 in an embodiment of the present invention. In this example, the microphone 750 is used to detect the audio surroundings 710 of the portable device, and these sounds are used to activate a slowdown mode and/or a speedup mode of the timing device. For example, a high level of sound might activate a speedup mode and a quiet environment might activate a slowdown mode. Pitch could also be used such as higher or lower frequencies activating a certain mode, or a specific frequencies. It is also possible to use sounds that are inaudible to the human ear but can be detected by the microphone to activate a certain mode. Additionally, the use of speech processing to detect the utterance of certain words or phrases could be used to activate a faster or slower adjustment mode.

Besides the touch based embodiments, the position/movement based embodiments, the visual based embodiments and the audio based embodiments discussed above, other sensors on the smartphone can be used to activate slowdown and speedup modes. Also, other mechanisms are used in some embodiments that are not based on sensor data but communication of the device with other devices. For example cellular or Internet messaging, near field communication (NFC), Bluetooth, Global Positioning System (GPS) and/or Bluetooth communications can be used to control a speedup or slowdown mode of the stopwatch feature. The configuration of certain interfaces, such as whether these interfaces are activated, could be used and also communication received over the interfaces could be used. For example, if a certain message is received over a Wi-Fi or cellular data connection it could activate a certain mode, or if the phone is placed in proximity to a specific NFC tag, it may activate a certain mode. The user of the device might use an accomplice or some external triggering mechanism to send an electronic message to the portable device which would then activate the desired mode. An advantage of this arrangement is that it would not require any physical manipulation of the device and as such the device could be placed into the hands of the unsuspecting observer to operate.

In some embodiments, only a single mode (for example speedup only or slowdown only) may be desirable so there may not be a need for both types of timing adjustment. Some embodiments may utilize different input mechanisms for triggering a speedup mode than for triggering a slowdown mode. Any of the types of inputs discussed above may be used in any combination for embodiments in which both speedup and slowdown modes are present. For example, a touch screen input may be used to activate a slowdown mode and an imaging input may be used to trigger a speedup mode. Also, multiple input mechanisms may be simultaneously present. Any of the input mechanisms discussed above may be used together in any combination. For example, the touch screen input and an imaging input may be used together, either one of which if present would activate a slowdown or speedup mode depending on the configuration.

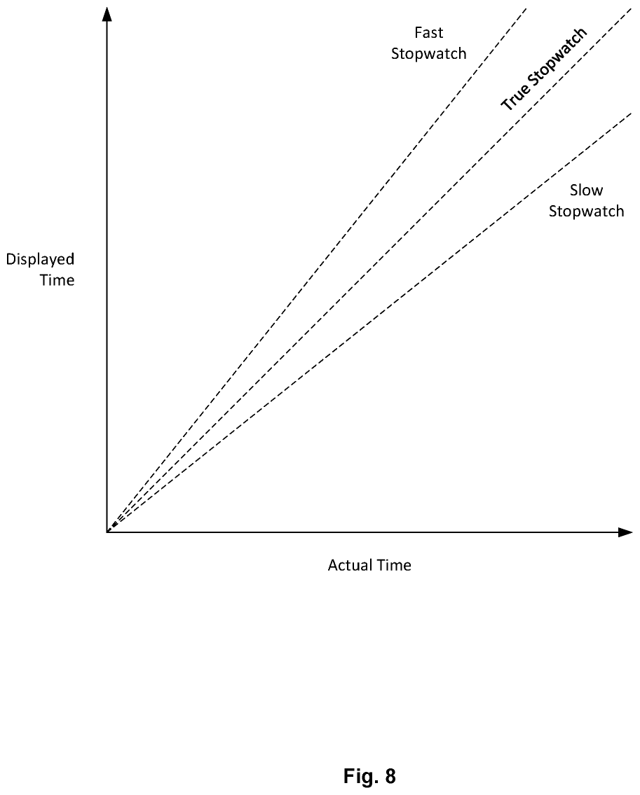

FIG. 8 illustrates a graph illustrating the concept of embodiments of the present invention. The horizontal axis represents actual time and the vertical axis represents displayed time. An accurate timing device would display time accurately, therefore would be represented by points along the “True Stopwatch” dashed line, which has a slope of 1 in FIG. 8. A “Slow Stopwatch” is represented by the lower dashed line in FIG. 8, having a slope of less than one, in which the displayed time is less than the actual time. A “Fast Stopwatch” is represented by the upper dashed line in FIG. 8, having a slope of more than one, in which the displayed time is greater than the actual time.

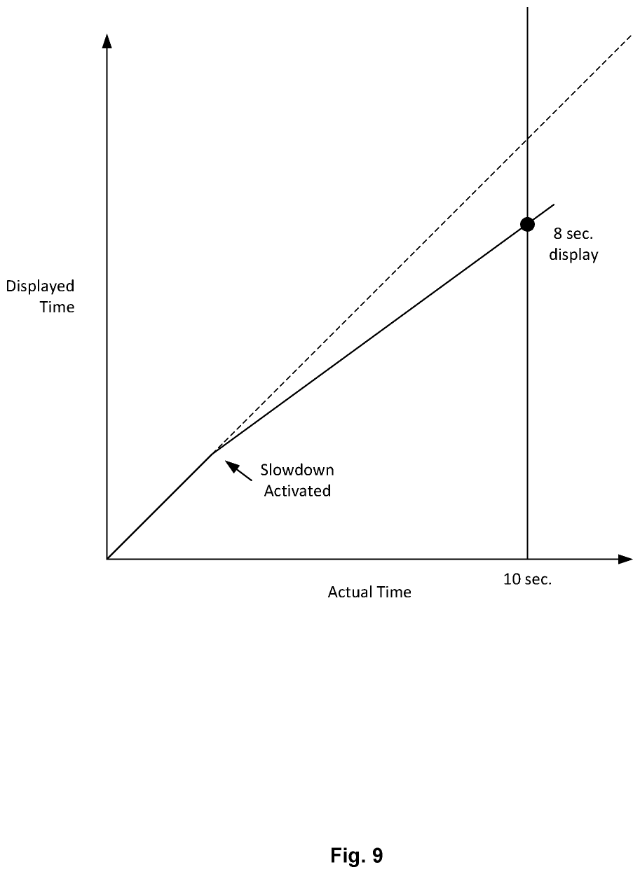

FIG. 9 illustrates a graph of an embodiment of a slowdown mode. The stopwatch starts out accurately keeping time until at one point a slowdown is activated according to one of the mechanisms discussed above. In this example, after 10 seconds of actual time the display will show eight seconds. In some embodiments, the rate at which time slows down in a slowdown mode takes place within a limited range, for example within 80% to 100% of actual time. In certain embodiments the slowdown rate is configurable by the user and may be set to a different value, for example 75% or 90% of actual time. In some embodiments, a slowdown is activated during a first interval (for example when the user is activating a control such as described above) and the rate of timing will return to actual time when the control is not being activated. This will result in an accumulation of error during the time of user activation, but not a continuous accumulation of error. In other embodiments, the degree of slowdown is incrementally adjusted with each user input. For example, a first user input could result in a continuing 95% rate and a second user input could result in a 90% rate. Other combinations of the rate of slowdown based on the manner and timing of user input are possible.

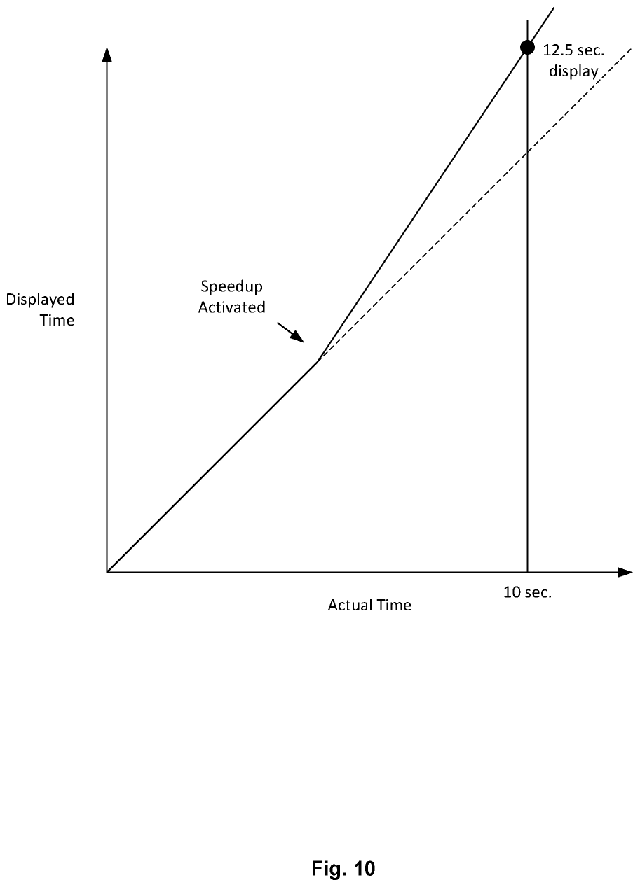

FIG. 10 illustrates a graph of an embodiment of a speedup mode. The stopwatch starts out accurately keeping time until at one point a speedup is activated according to one of the mechanisms discussed above. After 10 second of actual time the display will show 12.5 seconds in this example. In some embodiments, the rate at which time speeds up in a speedup mode takes place within a limited range, for example within 120% to 100% of actual time. In certain embodiments the speedup rate is configurable by the user and may be set to a different value, for example 125% or 110% of actual time. In some embodiments, a speedup is activated during a first interval (for example when the user is activating a control such as described above) and the rate of timing will return to actual time when the control is not being activated. This will result in an accumulation of error during the time of user activation, but not a continuous accumulation of error. In other embodiments, the degree of speedup is incrementally adjusted with each user input. For example, a first user input could result in a continuing 105% rate and a second user input could result in a 110% rate. Other combinations of the rate of speedup based on the manner and timing of user input are possible.

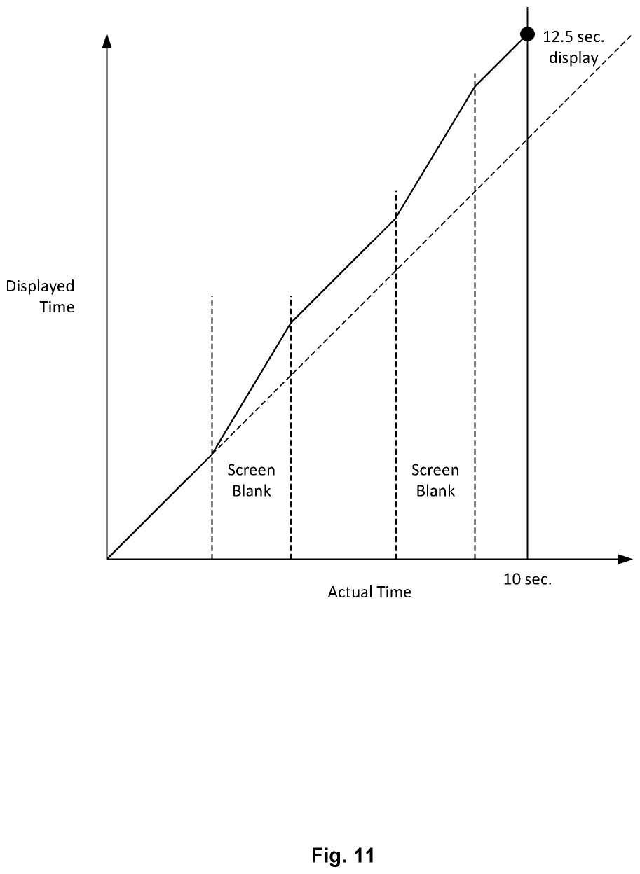

FIG. 11 illustrates a graph of an embodiment of a speedup mode. In this example screen blanking is used as an opportunity to advance time when a speedup mode has been activated according to one of the mechanisms discussed above. In this example the display will always be shown advancing at an accurate rate when the display is activated. During a period of screen blank the time will advance faster than normal. An advantage of this mode is that it may be less noticeable to the casual observer. Screen blanking is common in portable devices to conserve power and this mode may utilize the screen blanking periods that occur normally based on lack of user input. The use of screen blanking can also be used with slowdown modes discussed above, and the various user input scenarios discussed above can be used with screen blanking in both speedup and slowdown modes of operation.

In some embodiments, slowdown and speedup modes are both used and the timing adjustment is cumulative. In this case, a slowdown mode may cause the elapsed time to show less than the actual time and a subsequent activate of a speedup mode may cause the elapsed time to gradually return to actual time. In other embodiments, a slowdown and speedup mode are not cumulative but will cause an adjustment to be made based on an adjustment from the actual time rather than an adjustment from the currently displayed time. In some embodiments, an adjusted display different than the actual time is displayed during an intermediate step, such as an ongoing display or a “lap” display, and the adjustment may reset to actual time at a later point. For example, the display may show a paused lap time that is adjusted, but once timing continues or is stopped, the actual time may be displayed.

The present invention has been described above in connection with several embodiments. This has been done for purposes of illustration only, and variations of the inventions will be readily apparent to those skilled in the art and also fall within the scope of the invention.

1. A portable device comprising:
a display incorporating a touch screen;
one or more processors;
a storage medium with instructions for said one or more processors wherein execution of said instructions by said one or more processors cause said one or more processors to perform the steps of:
displaying a stopwatch interface comprising a display region capable of displaying a time elapsed and a control region capable of displaying stopwatch controls;
starting a timing operation upon selection of a start control in said control region, wherein an actual time elapsed is available based on an accurate measurement of real time;
detecting audio input, wherein when said audio input is detected a timing adjustment is determined, wherein said audio input comprises sounds that are inaudible to the human ear; and
displaying an elapsed time in said display region based on said timing adjustment that is inaccurate in comparison to the actual time that has elapsed.

2. The apparatus of claim 1, wherein said timing adjustment constitutes a speedup such that said elapsed time displayed is greater than the actual time that has elapsed.

3. The apparatus of claim 1, wherein said timing adjustment constitutes a slowdown such that said elapsed time displayed is less than the actual time that has elapsed.

4. The apparatus of claim 1 wherein said instructions cause said one or more processors to further perform the step of: before said step of detecting audio input, displaying an elapsed time in said display region that is accurate in comparison to the actual time that has elapsed.

5. The apparatus of claim 1 wherein said instructions cause said one or more processors to further perform the step of: detecting second audio input, wherein when said second audio input is detected a second timing adjustment is determined, wherein said second audio input comprises sounds that are inaudible to the human ear.

6. A computer-implemented method of displaying time elapsed comprising:
providing a portable device comprising a touch screen;
displaying a stopwatch interface comprising a display region capable of displaying a time elapsed and a control region capable of displaying stopwatch controls;
starting a timing operation upon selection of a start control in said control region, wherein an actual time elapsed is available based on an accurate measurement of real time;
detecting audio input, wherein when said audio input is detected a timing adjustment is determined, wherein said audio input comprises sounds that are inaudible to the human ear; and
displaying an elapsed time in said display region based on said timing adjustment that is inaccurate in comparison to the actual time that has elapsed.

7. The method of claim 16, wherein said timing adjustment constitutes a speedup such that said elapsed time displayed is greater than the actual time that has elapsed.

8. The method of claim 16, wherein said timing adjustment constitutes a slowdown such that said elapsed time displayed is less than the actual time that has elapsed.

9. The method of claim 16, further comprising the step of: before said step of detecting audio input, displaying an elapsed time in said display region that is accurate in comparison to the actual time that has elapsed.

10. The method of claim 16, further comprising step of: detecting second audio input, wherein when said second audio input is detected a second timing adjustment is determined, wherein said second audio input comprises sounds that are inaudible to the human ear.
